(19) United States
(12) Patent Application Publication
(10) Pub. No.: US 2013/0068720 A1
(43) Pub. Date: Mar. 21, 2013

(54) PATTERN FORMING METHOD

(71) Applicant: Shuichi TANIGUCHI, Kanagawa-ken (JP)

(72) Inventor: Shuichi TANIGUCHI, Kanagawa-ken (JP)

(21) Appl. No.: 13/415,036

(22) Filed: Mar. 8, 2012

(30) Foreign Application Priority Data
Sep. 16, 2011 (JP) 2011-203848

(51) Int. Cl. B29C 59/00

(52) U.S. Cl. 216/13

(57) ABSTRACT

According to one embodiment, a method includes: forming a film to be processed having a step; forming an uncured first imprint resist; curing the first imprint resist, with a flat surface of a first template pressed against a front surface of the first imprint resist, and planarizing the front surface; forming an intermediate transfer film made of a material different from a material of the first imprint resist; forming an uncured second imprint resist made of a material different from the material of the intermediate transfer film; curing the second imprint resist, with irregularities of a second template contacted with the second imprint resist, and forming an irregular pattern having the irregularities inverted on the second imprint resist; processing the intermediate transfer film by etching using the second imprint resist; and processing the film by etching using the processed intermediate transfer film.

### CROSS-REFERENCE TO RELATED APPLICATIONS

This application is based upon and claims the benefit of priority from the prior Japanese Patent Application No.2011-203848, filed on Sep. 16, 2011; the entire contents of which are incorporated herein by reference.

### FIELD

Embodiments described herein relate generally to a pattern forming method.

### BACKGROUND

For example, in manufacture of semiconductor devices, there are process steps in which the patterns of a plurality of electrode layers or the like are stacked through an interlayer insulating film. The interlayer insulating film is formed on a base so as to cover a lower layer pattern. A step is sometimes produced on the front surface of the interlayer insulating film formed on the lower layer pattern because of the density of the lower layer pattern. If the step is large, the step affects the processing of an upper layer pattern.

### BRIEF DESCRIPTION OF THE DRAWINGS

FIG. 1A to FIG. 1D are schematic cross-sectional views illustrating a pattern forming method according to this embodiment;

FIG. 2A to FIG. 2C are schematic cross-sectional views illustrating a pattern forming method according to this embodiment;

FIG. 3A to FIG. 3C are schematic cross-sectional views illustrating a pattern forming method according to this embodiment;

FIG. 4 is a schematic cross-sectional view illustrating a pattern forming method according to the embodiment; and

FIG. 5A and 5B are schematic cross-sectional views illustrating a pattern forming method according to a comparative example.

### DETAILED DESCRIPTION

In general, according to one embodiment, a pattern forming method includes: forming a film to be processed having a step; forming an uncured first imprint resist on the film to be processed; curing the first imprint resist, with a flat surface of a first template pressed against a front surface of the first imprint resist, and planarizing the front surface of the first imprint resist;

forming, on the front surface of the first imprint resist, an intermediate transfer film made of a material different from a material of the first imprint resist; forming, on the intermediate transfer film, an uncured second imprint resist made of a material different from the material of the intermediate transfer film; curing the second imprint resist, with irregularities of a second template contacted with the second imprint resist, and forming an irregular pattern having the irregularities inverted on the second imprint resist; processing the intermediate transfer film by etching using the second imprint resist formed with the irregular pattern as a mask; and processing the film to be processed by etching using the processed intermediate transfer film as a mask.

An embodiment of the invention will now be described with reference to the drawings. In the drawings, components similar to those described or illustrated in a drawing thereinabove are marked with like reference numerals.

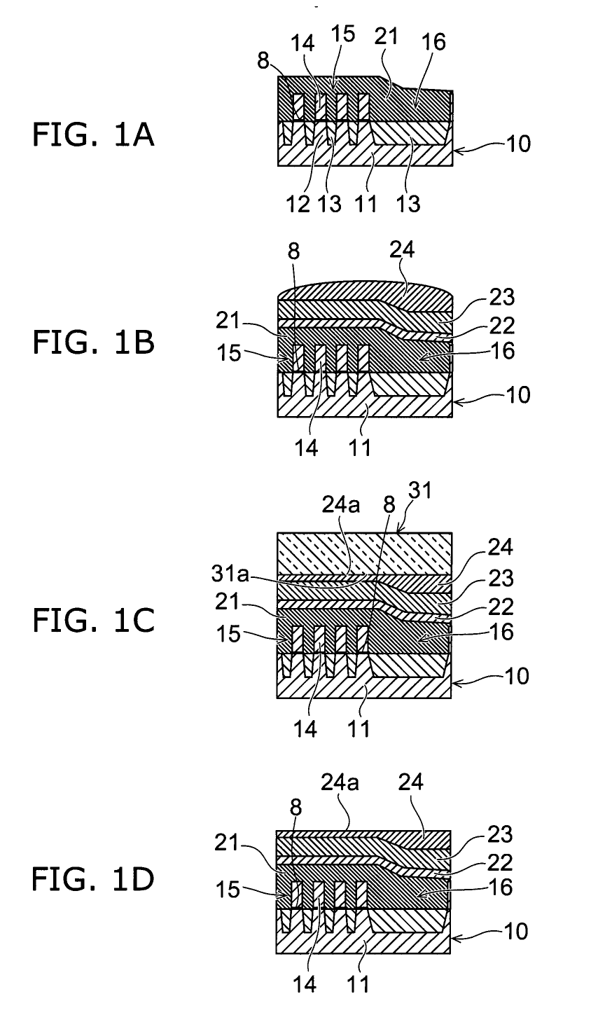

FIG. 1A to FIG. 3C are schematic cross-sectional views illustrating a pattern forming method according to this embodiment.

FIG. 1A shows the cross section of a base 10 and an interlayer insulating film 21 provided thereon. For example, the base 10 has a structure in which a lower layer pattern is formed on the front surface of a substrate 11.

The substrate 11 is a silicon substrate, for example, and an active region 12 is formed on the front surface, through which a current is carried. A plurality of active regions 12 are arranged in a first direction (the horizontal direction in the drawing) as isolated from each other by a device isolation region 13. Each of the active regions 12 extends in a second direction orthogonal to the first direction (in a direction penetrating the paper surface).

The device isolation region 13 has a shallow trench isolation (STI) structure, for example, in which an insulating film such as a silicon oxide film is buried in the inside of a trench.

The lower layer pattern has a first electrode 14 provided on the active region 12 through an insulating film 8. For example, the first electrode 14 extends in the second direction as similar to the active region 12.

The lower layer pattern has a densely patterned portion 15 in which the first electrode 14 is relatively densely laid out and a non-densely patterned portion 16 in which the first electrode 14 is relatively non-densely laid out. A pitch between the first electrodes 14 in the densely patterned portion 15 is smaller than a pitch between the first electrodes 14 in the non-densely patterned portion 16.

The interlayer insulating film 21 such as a silicon oxide film, for example, is formed on the base 10 having the densely and non-densely patterned portions so as to cover the densely and non-densely patterned portions.

The density of the base pattern produces a step on the front surface of the interlayer insulating film 21. Namely, the front surface of the interlayer insulating film 21 on the non-densely patterned portion 16 falls on the substrate 11 side with respect to the front surface of the interlayer insulating film 21 on the densely patterned portion 15.

The step on the front surface of the interlayer insulating film 21 can be reduced by chemical mechanical polishing (CMP), for example, or the like to some extent. However, it is difficult to completely eliminate the step.

As shown in FIG. 1B, a second electrode 22, for example, is formed, as a film with a step to be processed, on the front surface of the interlayer insulating film 21. In this stage, the second electrode 22 is formed on the entire front surface of the interlayer insulating film 21. A step reflecting the step on the front surface of the interlayer insulating film 21 is produced also on the front surface of the second electrode 22.

The second electrode 22 is patterned by selective etching in process steps described later. This embodiment is to provide a pattern forming method that can excellently process the pattern of this second electrode 22.

As shown in FIG. 1B, a lower layer resist film 23 is formed on the second electrode 22. The lower layer resist film 23 is an organic film containing carbon, for example. A step reflecting the step on the front surface of the interlayer insulating film 21 is produced also on the front surface of the lower layer resist film 23.

Subsequently, a first imprint resist 24 is formed on the lower layer resist film 23. The first imprint resist 24 is an ultraviolet curable resin, for example, which is supplied over the lower layer resist film 23 in uncured liquid or paste.

Subsequently, a first template 31 shown in FIG. 1C is used to planarize the front surface of the first imprint resist 24.

The first template 31 is made of silica transparent to ultraviolet rays. As shown in FIG. 1C, the first template 31 has a flat surface 31a. The flat surface 31a is contacted with and pressed against the uncured first imprint resist 24.

Ultraviolet rays are applied onto the first imprint resist 24 from above the first template 31 (on the opposite side of the flat surface 31a). The application of these ultraviolet rays cures the first imprint resist 24. Thus, the front surface of the first imprint resist 24 is planarized.

As shown in FIG. 1D, after curing the first imprint resist 24, the first template 31 is released from the first imprint resist 24. A flat surface 24a transferred from the first template 31 is formed on the front surface of the first imprint resist 24.

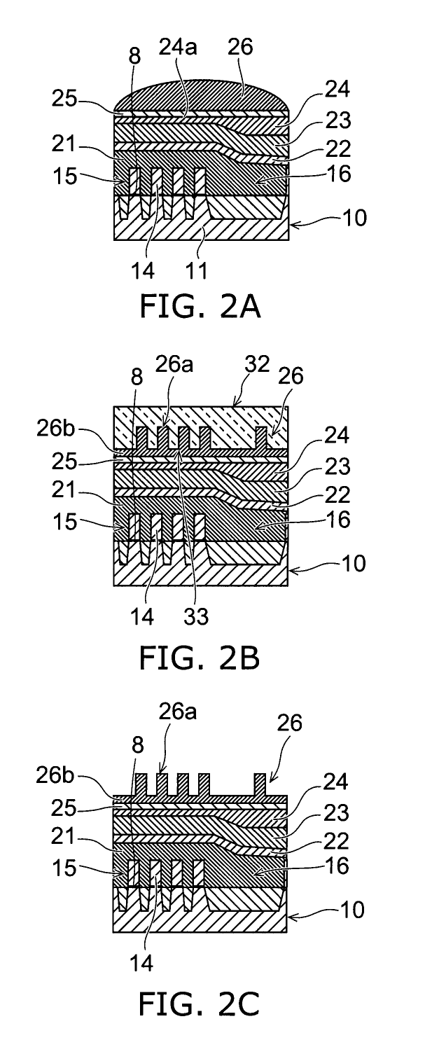

Subsequently, as shown in FIG. 2A, an intermediate transfer film 25 is formed on the flat surface 24a of the first imprint resist 24.

The intermediate transfer film 25 is made of a material different from the material of the first imprint resist 24, containing silicon and oxygen. The intermediate transfer film 25 is a silicon oxide film made of tetraethoxysilane (TEOS) and formed by spin on glass (SOG), for example. The intermediate transfer film 25 is thinner than the lower layer resist film 23.

The intermediate transfer film 25 is formed on the flat surface 24a of the first imprint resist 24. Thus, the front surface of the intermediate transfer film 25 is flat.

Subsequently, a second imprint resist 26 is formed on the intermediate transfer film 25. The second imprint resist 26 is an ultraviolet curable resin, which is supplied over the intermediate transfer film 25 in uncured liquid or paste.

For the material of the second imprint resist 26, the same material as the material of the first imprint resist 24 can be used, for example. This embodiment includes two imprinting process steps. The same material is used for the first imprint resist 24 and the second imprint resist 26 for use in the imprinting process steps, so that it is possible to facilitate the setting of conditions and management for further cost reductions.

Subsequently, a second template 32 shown in FIG. 2B is used to form an irregular pattern 26a on the second imprint resist 26.

The second template 32 is made of silica, for example, transparent to ultraviolet rays. As shown in FIG. 2B, the second template 32 has irregularities 33 on one surface thereof. The irregularities 33 are contacted with and pressed against the uncured second imprint resist 26. The second imprint resist 26 is filled in the recesses of the second template 32.

Ultraviolet rays are applied onto the second imprint resist 26 from above the second template 32 (on the opposite side of the irregular surface). The application of these ultraviolet rays cures the second imprint resist 26. As shown in FIG. 2C, after curing the second imprint resist 26, the second template 32 is released from the second imprint resist 26.

Thus, the irregular pattern 26a is formed on the second imprint resist 26. This irregular pattern 26a is the inverted pattern of the irregularities 33 of the second template 32.

The second imprint resist 26 is left below the recesses of the irregular pattern 26a. Namely, a remaining portion 26b of the second imprint resist 26 is formed between the irregular pattern 26a and the intermediate transfer film 25. The film thickness of the remaining portion 26b is uniform in a surface direction. A film thickness difference is not produced between the remaining portion 26b on the densely patterned portion 15 of the lower layer pattern and the remaining portion 26b on the non-densely patterned portion 16 of the lower layer pattern.

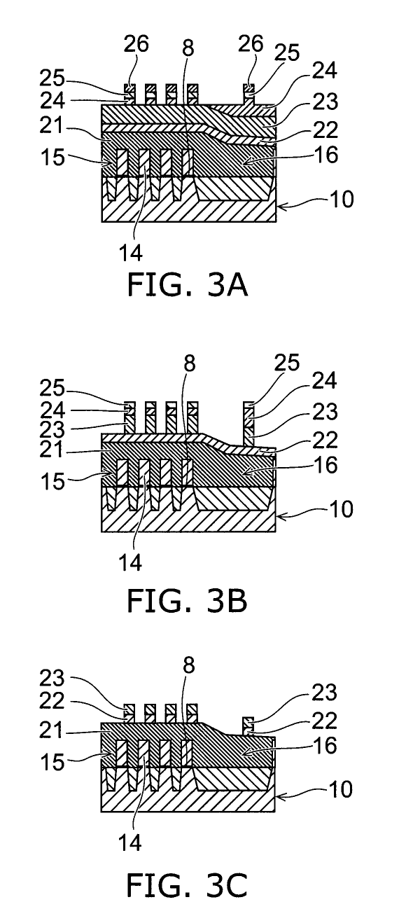

Subsequently, as shown in FIG. 3A, the second imprint resist 26 formed with the irregular pattern 26a is used as a mask to in turn etch the intermediate transfer film 25 and the first imprint resist 24. This etching is performed by reactive ion etching (RIE), for example.

As shown in FIG. 3B, the processed intermediate transfer film 25 is used as a mask to etch the lower layer resist film 23. This etching is also performed by RIE, for example. In etching this lower layer resist film 23, the second imprint resist 26 made of the same organic material as the material of the lower layer resist film 23 is eliminated above the intermediate transfer film 25.

As shown in FIG. 3C, the remaining intermediate transfer film 25 and the processed lower layer resist film 23 are used as a mask to etch the second electrode 22, which is a film to be processed. This etching is also performed by RIE, example.

The second imprint resist 26 for processing the intermediate transfer film 25 is made of an organic material, having a RIE resistance lower than the RIE resistance of a material of a so-called hard mask made of silicon oxide and a large power consumption in RIE. Thus, if the intermediate transfer film 25 is too thick, it is likely that the irregular pattern 26a of the second imprint resist 26 is eliminated before finishing the processing of the intermediate transfer film 25. Therefore, the film thickness of the intermediate transfer film 25 is thinner than the thickness of a typical resist film, having a thickness of about a few tens nanometers, for example.

Since the intermediate transfer film 25 is thin as described above, it is likely that the intermediate transfer film 25 is eliminated in processing the second electrode 22 using the intermediate transfer film 25 as a mask. Therefore, in this embodiment, the lower layer resist film 23 thicker than the intermediate transfer film 25 is formed on the second electrode 22. Namely, the lower layer resist film 23 is added to the film thickness of the mask necessary for processing the second electrode 22. The lower layer resist film 23 is made of a resin material, which can be readily formed thick by coating, for example.

After processing the second electrode 22, the remaining lower layer resist film 23 is removed from the second electrode 22.

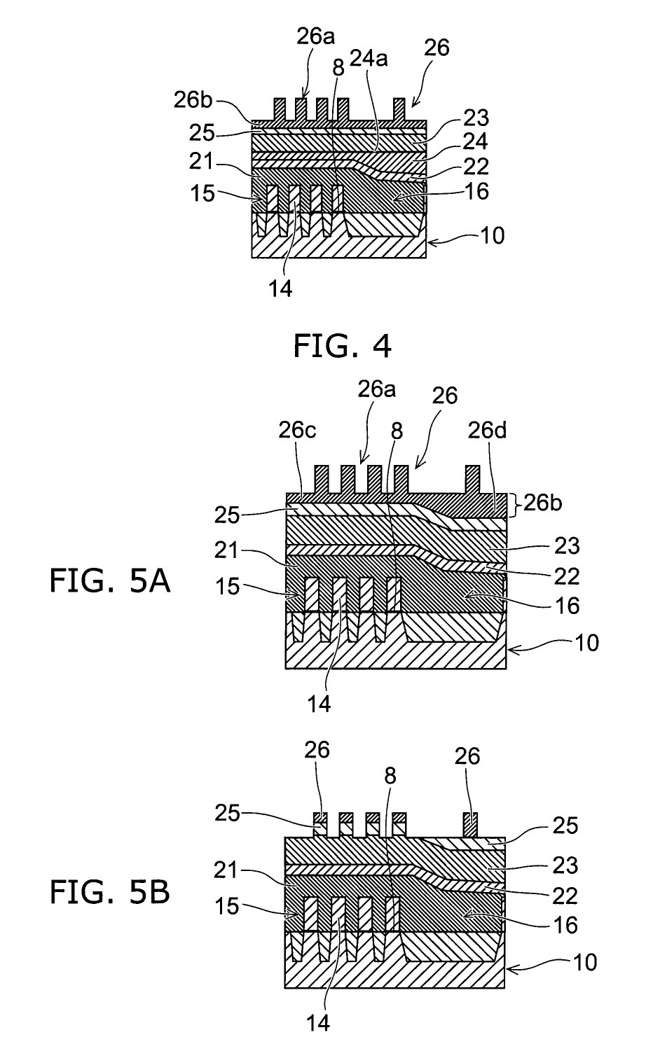

It is noted that the lower layer resist film 23 may be formed between the first imprint resist 24 and the intermediate transfer film 25 as shown in FIG. 4. Namely, the first imprint resist 24 is supplied over the second electrode 22, and then planarized using the first template 31. The lower layer resist film 23 and the intermediate transfer film 25 are in turn formed on the flat surface 24a. The front surface of the lower layer resist film 23 formed on the flat surface 24a is flat, and the front surface of the intermediate transfer film 25 formed on the flat surface of the lower layer resist film 23 is also made flat.

Here, a pattern forming method according to a comparative example will be described with reference to FIG. 5A and FIG. B.

In this comparative example, as shown in FIG. 5A, a lower layer resist film 23 and an intermediate transfer film 25 are in turn formed on a second electrode 22. In the stage before forming the intermediate transfer film 25, a step is produced on the front surface of a layer below the intermediate transfer film 25 caused by dense and non-dense portions of a lower layer pattern. Thus, a step is also produced on the front surface of the intermediate transfer film 25.

An imprint resist 26 for forming an irregular pattern is supplied over the intermediate transfer film 25, and an irregular pattern 26a is transferred to the imprint resist 26 through a template.

Generally, in imprinting, the tip end of the projection of the irregularities of the template is not strongly pressed against the layer (the intermediate transfer film 25 in FIG. 5A) below the imprint resist 26 in consideration of damaging structures below the imprint resist 26.

Therefore, the imprint resist 26 exists between the tip end of the projection of the template and the intermediate transfer film 25 in the state in which the irregularities of the template are contacted with the imprint resist 26. Thus, after curing the imprint resist 26, the imprint resist 26 is left between the bottom part of the recess of the irregular pattern 26a and the intermediate transfer film 25.

If the front surface of the intermediate transfer film 25 has a step like the comparative example, the film thickness of a remaining portion 26b below the irregular pattern 26a of the imprint resist 26 is not uniform. In FIG. 5A, the film thickness of a remaining portion 26c is relatively thin on a densely patterned portion 15 of the lower layer, and the film thickness of a remaining portion 26d is relatively thick on a non-densely patterned portion 16.

When the imprint resist 26 having a film thickness difference in the remaining portion 26b below the irregular pattern 26a is used as a mask to etch the lower layer, this causes the patterning failure of the lower layer.

Namely, as shown in FIG. 5B, it is likely that the intermediate transfer film 25 below the portion where the film thickness of the remaining portion 26b is thick is still being processed when finishing the processing of the intermediate transfer film 25 below the portion where the film thickness of the remaining portion 26b is thin. The patterning failure of the intermediate transfer film 25 causes the patterning failure of the lower layer using the intermediate transfer film 25 as a mask.

Alternatively, it is likely that etching is performed excessively in the portion where the film thickness of the remaining portion 26b is thin to eliminate the intermediate transfer film 25 above the densely patterned portion 15.

It can also be considered that the front surface of the lower layer resist film 23 is planarized using the lower layer resist film 23 with a low viscosity. However, the resist with a low viscosity generally tends to have a low RIE resistance, and it is difficult to perform planarization in priority in selecting resist materials.

On the contrary, in this embodiment, the surface on which the intermediate transfer film 25 is formed is planarized by imprinting using the first template 31 having the flat surface 31a as discussed above. Thus, the front surface of the intermediate transfer film 25 formed on the flat surface is made flat.

Therefore, as shown in FIG. 2C, it is possible to uniformize the film thickness of the remaining portion 26b below the irregular pattern 26a of the second imprint resist 26 to be a mask for processing the intermediate transfer film 25. Thus, it is possible to suppress the processing failure of the intermediate transfer film 25 caused by a difference in the film thickness of the remaining portion 26b, and it is possible to suppress the processing failure of the film to be processed (the second electrode 22) using the processed intermediate transfer film 25 as a mask.

It is noted that it is also possible to allow the first imprint resist 24 to function as the intermediate transfer film 25 using a resist containing silicon for the first imprint resist 24 for planarization. Namely, it is likely that the film thickness of the intermediate transfer film is substantially increased and the second electrode 22 can be processed using only the intermediate transfer film 25 and the first imprint resist 24, without forming the lower layer resist film 23.

The martial for the first imprint resist 24 and the second imprint resist 26 is not necessarily the same. Different materials may be used for the first imprint resist 24 and the second imprint resist 26. The conditions of applying ultraviolet rays (intensity, time, or the like) to the first imprint resist 24 may be the same as the conditions of applying ultraviolet rays to the second imprint resist 26, or the conditions may be different from each other.

It is unlikely that the first imprint resist 24 for planarization damages the irregular pattern in releasing the first template 31, so that it is possible to harden the first imprint resist 24 more than the second imprint resist 26, for example.

The explanation is given that the cause to produce a step in the film to be processed is forming the film to be processed on the base having densely and non-densely patterned portions. However, this embodiment is applicable whenever a step is produced on the film to be processed whatever the cause.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A pattern forming method comprising:
forming a film to be processed having a step;
forming an uncured first imprint resist on the film to be processed;
curing the first imprint resist, with a flat surface of a first template pressed against a front surface of the first imprint resist, and planarizing the front surface of the first imprint resist;
forming, on the front surface of the first imprint resist, an intermediate transfer film made of a material different from a material of the first imprint resist;
forming, on the intermediate transfer film, an uncured second imprint resist made of a material different from the material of the intermediate transfer film;
curing the second imprint resist, with irregularities of a second template contacted with the second imprint resist, and forming an irregular pattern having the irregularities inverted on the second imprint resist;
processing the intermediate transfer film by etching using the second imprint resist formed with the irregular pattern as a mask; and
processing the film to be processed by etching using the processed intermediate transfer film as a mask.

2. The method according to claim 1, further comprising:
forming a lower layer resist film between the film to be processed and the first imprint resist, the lower layer resist film being made of a material different from the material of the intermediate transfer film and being thicker than the intermediate transfer film.

3. The method according to claim 2,
wherein the lower layer resist film is an organic film containing carbon.

4. The method according to claim 3,
wherein the intermediate transfer film contains silicon and oxygen.

5. The method according to claim 4,
wherein the intermediate transfer film is a silicon oxide film.

6. The method according to claim 1, further comprising:
forming a lower layer resist film between the first imprint resist and the intermediate transfer film, the lower layer resist film being made of a material different from the material of the intermediate transfer film and thicker than the intermediate transfer film.

7. The method according to claim 6,
wherein the lower layer resist film is an organic film containing carbon.

8. The method according to claim 7,
wherein the intermediate transfer film contains silicon and oxygen.

9. The method according to claim 8,
wherein the intermediate transfer film is a silicon oxide film.

10. The method according to claim 1,
wherein the material of the first imprint resist and the material of the second imprint resist are a same material, and cured by applying an ultraviolet ray.

11. The method according to claim 10,
wherein the intermediate transfer film contains silicon and oxygen.

12. The method according to claim 11,
wherein the intermediate transfer film is a silicon oxide film.

13. The method according to claim 1, wherein:
a remaining portion of the second imprint resist is formed between the irregular pattern and the intermediate transfer film when forming the irregular pattern on the second imprint resist; and
a film thickness of the remaining portion is uniform in a surface direction of the intermediate transfer film.

14. The method according to claim 1,
wherein the first imprint resist contains silicon.

15. The method according to claim 1, further comprising:
forming a lower layer pattern having a densely patterned portion and a non-densely patterned portion on a substrate; and
forming an interlayer insulating film covering the lower layer pattern on the substrate,
the film to be processed being formed on the interlayer insulating film.
